(19) United States
(12) Patent Application Publication
(10) Pub. No.: US 2016/0092634 A1
(43) Pub. Date: Mar. 31, 2016

(54) METHOD AND MEDICAL IMAGING APPARATUS FOR OPTIMIZING AN EXAMINATION

(71) Applicant: Siemens Aktiengesellschaft, Muenchen (DE)

(72) Inventor: Maria Kroell, Erlangen (DE)

(73) Assignee: Siemens Aktiengesellschaft, Muenchen (DE)

(21) Appl. No.: 14/864,997

(22) Filed: Sep. 25, 2015

(30) Foreign Application Priority Data
Sep. 25, 2014 (DE) 102014219405.9

(51) Int. Cl. G06F 19/00

(52) U.S. Cl. CPC G06F 19/321; G06F 19/322

(57) ABSTRACT

A method for optimizing an examination implemented by a medical imaging apparatus includes selection of at least one information protocol, that includes at least one information parameter, display of at least one examination protocol, that includes at least one examination parameter from an examination protocol catalog of a server unit in accordance with the selected information protocol, selection of an examination protocol, and transfer of the selected examination protocol from the server to the processor of the medical imaging apparatus.

### BACKGROUND OF THE INVENTION

1. Field of the Invention

The present invention concerns a method for optimizing an examination implemented by a medical imaging apparatus, a test apparatus and a server. The invention also concerns a correspondingly designed medical imaging apparatus, test apparatus, server and computer-readable storage medium that enable the execution of such a method.

2. Description of the Prior Art

The optimization of examinations with a medical imaging apparatus is a common need, particularly in clinical applications.

In everyday clinical practice, an examination by a medical imaging apparatus can present a complex problem, especially if multiple examination parameters and apparatus parameters are available.

### SUMMARY OF THE INVENTION

An object of the invention is to provide a method that facilitates optimization of an examination, in particular optimization of examination parameters.

A method for optimizing an examination implemented by a medical imaging apparatus in accordance with the invention includes the following steps.

At least one information protocol, that includes at least one information parameter, is selected.

At least one examination protocol is displayed, that includes at least one examination parameter from an examination protocol catalog of a server in accordance with the selected information protocol.

An examination protocol that is displayed is selected.

The selection examination protocol is transferred (which may be only the display of the parameters for copying) from the server unit to the processing unit of the medical imaging device.

A medical imaging apparatus is an apparatus, preferably an electronic and/or information-technology apparatus, for recording (acquiring), processing, evaluating and/or storing image information in the form of image data. For the recording of image information, acoustic methods such as ultrasound (US), emission methods such as emission computed tomography (ECT) and positron emission tomography (PET), optical methods and radiological methods such as x-ray tomography and computed tomography (CT) can be used, for example. Image information also can be recorded by magnetic resonance tomography (MR or MRT) or combined methods. The medical imaging apparatus can supply 2-dimensional (2D) or multidimensional, such as 3-dimensional (3D) or 4-dimensional (4D), image data, which preferably can be stored and/or processed in different formats. The medical imaging apparatus can be used in diagnostics, for example in medical diagnostics.

An information protocol as used herein means a protocol that includes at least one information parameter. An information parameter may be, for example (but not exclusively):
a type of institution, such as e.g. a university clinic, a hospital or an imaging center,
a number of rooms and/or beds,
a hardware version of a medical imaging device used,
a software version of a medical imaging device used,
qualitative examination targets, such as e.g. an examination time, a noise level or an image resolution,
patient data, such as e.g. age, height, physique or breath- holding capabilities,
types of examination protocols, such as e.g. body region, contrast agent, relaxation times or a number of dimensions

Such an information protocol is again selected by a user, such as clinical operating personnel. In accordance with the information parameter thus selected, at least one examination protocol from an examination protocol catalog of a server unit is displayed.

An examination protocol as used herein means a protocol that includes at least one examination parameter. Possible values for the at least one examination parameter can be derived from an examination protocol catalog of a server, in accordance with the information protocol selected. The server may, for example but not exclusively, be a network of different imaging devices, a cloud system or a server architecture. The server provides a number of different examination protocols for a number of medical examination apparatus of different hardware and software versions.

Using the previously selected information protocol, examination protocols of similar medical imaging devices with similar software and hardware versions, with which similar problems and/or a similar patient population have been examined, can thus be shown. Alternatively, it is possible that the hardware and software versions and/or the other specified parameters must be identical.

The selection of an examination protocol thus shown is again preferably carried out by a user, such as clinical operating personnel, but it can also be carried out automatically on the basis of a match criterion determined by the server.

The examination protocol thereby selected is then transferred from the server computer to the processing computer of the medical imaging device. A transfer may be understood here as being a download of the examination protocol, but may also be a mere display or representation on an output device of the medical examination device, so that the examination parameters are then transferred manually to the medical examination device.

The method according to the invention makes it possible, via the examination protocol catalog, for data of a large user group to be used in order to help an individual user to find a suitable examination protocol that will meet his/her requirements for the examination and for the examination device. This saves having to spend time creating a separate examination protocol, and the user can utilize a reliable, comparable and tested protocol. Optimization of the examination protocol beyond the capabilities of the user can be carried out.

In a preferred embodiment, the method further includes an assessment of the transferred selected examination protocol. An assessment is to be understood here as being an evaluation of the executed examination protocol, i.e. of whether the expectations for the examination protocol were fulfilled. This evaluation can be effected by a traffic-light representation (green, amber, red), by a numerical-grade representation (from 1 to 6) or by a different representation with a different scale. The assessment here also includes a transfer of the assessment to the server. If this assessment is transferred back to the server, it can be used as an additional criterion for selecting an examination protocol. The assessment consequently allows a user to obtain information about the underlying method and thus helps the user to contribute to the user's decision. In particular, a number of assessments of a number of examination protocols are averaged in order to smooth out outliers and to offer a better cross-section of user experience.

In an embodiment, at least one information parameter of the information protocol is selected automatically. This is possible because the processor of the medical imaging system “know” hardware and software versions of the medical imaging system, for example. As a result, such variables can be read in automatically, which reduces the error susceptibility and the time required.

In a further embodiment, the selected examination protocol includes at least one guideline variable. A guideline variable as used herein can be, for example, a benchmark value or another comparative value, by which it can be estimated e.g. how successful the selected examination protocol has already been in the case of other preceding measurements of other users. Thus, it may be shown, for example, that it had already been possible with the selected examination protocol to obtain a reduced scan time. In this way, the impact of a parameter change can also be visualized and user convenience and operator safety can be enhanced.

In a preferred embodiment, the at least one examination protocol is displayed in accordance with the assessment of the transferred selected examination protocol. If the assessment according to the method is transferred back to the server, it may function as an additional criterion for the selection of an examination protocol. The assessment consequently allows a user to obtain information about the underlying method and thus helps the user to contribute to the user's decision. In particular, a number of assessments of a number of examination protocols are averaged in order to smooth out outliers and to offer a better cross-section of user experience. A direct display, for example, of an average evaluation, additionally enhances user convenience.

The present invention also encompasses a method for optimizing an examination implemented by a test apparatus of a medical imaging device. The method includes the following steps.

An examination protocol is created that includes at least one examination parameter.

An information protocol, that forms part of the examination protocol is created, the information protocol includes at least one information parameter.

The examination protocol and the information protocol are transferred to a server.

As used herein, a test apparatus means a medical imaging apparatus by which an examination protocol is tested and is then made available.

With the use of this method, those examination protocols that can be selected by the method for optimizing an examination by a medical imaging device are thus generated. In other words, with the use of this method, a database is generated.

Thus, first an examination protocol that includes at least one examination parameter is created. Creating as used herein means specifying the necessary examination parameters.

Then, an information protocol forming part of the examination protocol is created, the information protocol including at least one information parameter.

Analogously, an information parameter may, for example but not exclusively, be:
a type of institution, such as e.g. a university clinic, a hospital or an imaging center,
a number of rooms and/or beds,
a hardware version of a medical imaging device used,
a software version of a medical imaging device used,
qualitative examination targets, such as e.g. an examination time, a noise level or an image resolution,
patient data, such as e.g. age, height, physique or breath-holding capabilities,
types of examination protocols, such as e.g. body region, contrast agent, relaxation times or a number of dimensions

The examination protocol and the information protocol are subsequently transferred to a server, the protocols are thus also available to another user group for downloading later.

The generation of a database by implementation of this method according to the invention makes accessible examination protocols which enable another user group to adjust examination parameters quickly and reliably.

In an embodiment, the method further includes an assessment of the transferred examination protocol. An assessment as used herein means an evaluation of the executed examination protocol, i.e. of whether the expectations for the examination protocol were fulfilled. This evaluation can be effected by a traffic-light representation (green, amber, red), by a numerical-grade representation (from 1 to 6) or by a different representation with a different scale. The assessment here also includes a transfer of the assessment to the server. The assessment allows a user to obtain information about the underlying method and thus helps the user to contribute to the user's decision.

In a preferred embodiment, the assessment is stored as an information parameter. A user can consequently also search selectively for defined assessments and, for example, specify a threshold for an assessment value and thereby ensure that only protocols that lie e.g. above this threshold value are obtained.

In an embodiment according to the invention, at least one information parameter of the information protocol is selected automatically. This is possible because the processor of the test device should “know” hardware and software versions of the test device, for example. As a result, such variables can be read in automatically, which reduces the error susceptibility and the time required.

The present invention also encompasses a method for optimizing an examination by a server for categorizing examination protocols, the examination protocols respectively including at least one examination parameter, and information protocols forming part of the examination protocols. The information protocols each include at least one information parameter, that is transferred to the server, in accordance with information from the examination protocols and/or information protocols.

A categorization as used herein means, for example, a pooling or bundling according to a sort criterion. Thus, examination protocols of medical imaging devices with the same or similar specifications can be pooled or else averaged in order to obtain an optimum set of examination parameters. Such categorization is carried out, for example but not exclusively, with pattern recognition methods such as e.g. support vector machines, hidden Markov models or the like.

The present invention also encompasses a medical imaging apparatus for optimizing an examination, a test apparatus for optimizing an examination, and a server for optimizing an examination. Each of those systems or components or processors is configured to operate so as to implement the inventive method as described above.

The present invention furthermore encompasses a non-transitory, computer-readable storage medium that can be loaded in a memory of a programmable controller or a computer of a medical imaging apparatus and/or of a test device and/or of a server. The storage medium is encoded with programming instructions that cause the controller or computer to implement all or some of the above-described embodiments of the method according to the invention when the programming instructions are executed by the controller or control computer of the medical imaging apparatus and/or of the test device and/or of the server. Here, the programming instructions may need program means, e.g. libraries and help functions, in order to implement the corresponding embodiments of the method. The programming instructions may be a source code which has yet to be compiled and linked or which has only to be interpreted, or an executable software code which, in order to be executed, has only to be loaded into the corresponding computer.

The electronically readable storage medium may be, e.g. a DVD, a magnetic tape or a USB stick, on which electronically readable control information, in particular software, is stored.

The advantages of the test device according to the invention, the server according to the invention, the medical imaging apparatus according to the invention, and the electronically readable storage medium according to the invention essentially correspond to the advantages of the method according to the invention, as described in detail above. The functional features of the method are embodied as corresponding object modules, in particular by hardware modules.

### BRIEF DESCRIPTION OF THE DRAWINGS

FIG. 1 shows a number of medical imaging devices according to the invention, test devices according to the invention, and a server according to the invention.

FIG. 2 is a flowchart of the method according to the invention for optimizing an examination implemented by a medical imaging device.

FIG. 3 is a flowchart of the method according to the invention for optimizing an examination implemented by a test device.

### DESCRIPTION OF THE PREFERRED EMBODIMENTS

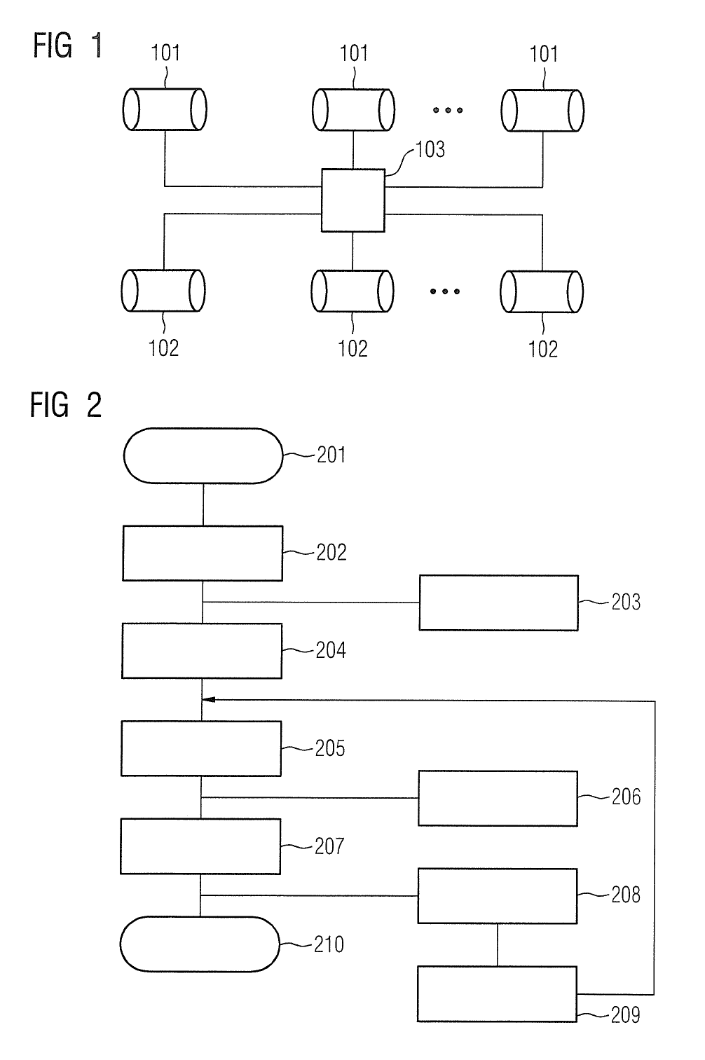

FIG. 1 shows a number of medical imaging apparatuses 101 according to the invention, test apparatuses 102 according to the invention, and a server 103 according to the invention.

The medical imaging apparatuses 101 are embodied here as magnetic resonance apparatuses. Alternatively, the medical imaging apparatuses 101 may be combined magnetic resonance/positron emission tomography apparatuses or other medical imaging apparatuses 101 that appear appropriate to those skilled in the art.

The method according to the invention for optimizing an examination implemented by a medical imaging apparatus 101 can be executed by at least one medical imaging apparatus 101. For the precise method sequence, reference is made to FIG. 2.

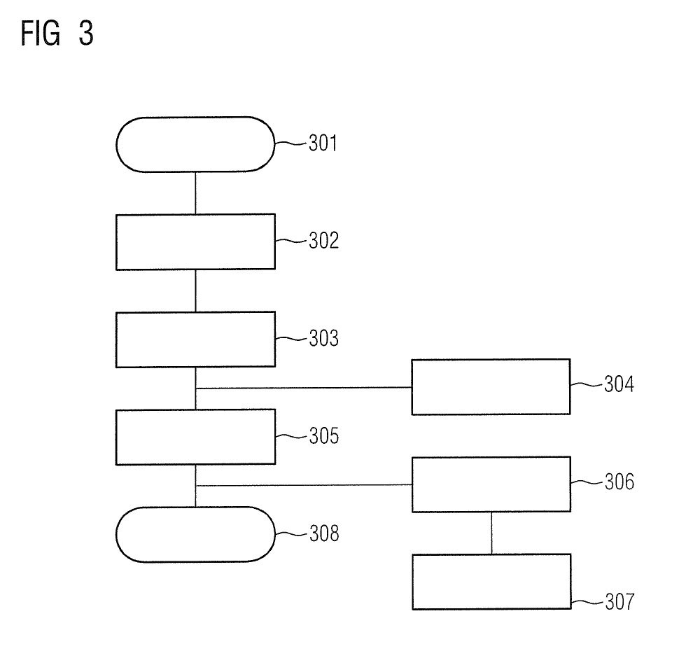

In order to obtain suitable protocols for this purpose, a method for optimizing an examination implemented by a test apparatus 102 can be implemented by at least one test apparatus 102. For the precise method sequence, reference is made to FIG. 3.

The server 103 categorizes examination protocols, the examination protocols each including at least one examination parameter, and information protocols forming part of the examination protocols. The information protocols each include at least one information parameter. The information protocols are transferred to the server 103, in accordance with information from the examination protocols and/or information protocols.

In other words, a database created by test apparatuses 102 is categorized by the server 103 so that the database is available to applications of medical imaging apparatuses 101.

FIG. 2 is a flowchart of the method according to the invention for optimizing an examination implemented by a medical imaging apparatus. The method includes steps 201 to 210, parts of the description including the corresponding reference characters introduced in connection with FIG. 1 also being used in the description of the method steps 201 to 210.

A first step 201 designates the start of the method for optimizing an examination by means of a medical imaging apparatus 101.

In step 202, at least one information protocol, that includes at least one information parameter, is selected.

An information protocol is a protocol that includes at least one information parameter. An information parameter may, for example but not exclusively, be:
a type of institution, such as e.g. a university clinic, a hospital or an imaging center,
a number of rooms and/or beds,
a hardware version of a medical imaging device 101 used,
a software version of a medical imaging device 101 used,
qualitative examination targets, such as e.g. an examination time, a noise level or an image resolution,
patient data, such as e.g. age, height, physique or breath-holding capabilities,
types of examination protocols, such as e.g. body region, contrast agent, relaxation times or a number of dimensions

In step 203, an optional step, at least one information parameter of the information protocol is selected automatically. This is possible, as the processing unit of the medical imaging system 101 should be familiar with, for example, hardware and software versions of the medical imaging apparatus 101. As a result, such variables can be read in automatically, which reduces the error susceptibility and the time required.

In step 204, display of at least one examination protocol takes place. Each displayed protocol includes at least one examination parameter, and is taken from an examination protocol catalog of a server 103 in accordance with the selected information protocol.

An examination protocol is a protocol that includes at least one examination parameter. Possible values for the at least one examination parameter derive from an examination protocol catalog of a server 103 in accordance with the selected information protocol. The server 103 may, for example but not exclusively, be a network of different imaging apparatuses, a cloud system or a server architecture. The server 103 provides a number of different examination protocols of a number of medical examination apparatuses 101 with different hardware and software versions. Using the previously selected information protocol, examination protocols of similar medical imaging devices 101 with similar software and hardware versions, with which similar problems and/or a similar patient population have been examined, can thus be shown. Alternatively, it is also possible that the hardware and software versions and/or the other specified parameters must be identical.

In step 205, an examination protocol is selected. This is preferably carried out by a user, such as clinical operating personnel, but it can also be carried out automatically on the basis of a match criterion determined by the server 103.

In step 206, an optional step, the selected examination protocol includes at least one guideline variable. A guideline variable is, for example, a benchmark value or another comparative value, by which it can be estimated e.g. how successful the selected examination protocol has already been in the case of other preceding measurements of other users. Thus, it may be shown, for example, that it had already been possible with the selected examination protocol to obtain a reduced scan time.

In step 207, a transfer of the selected examination protocol from the server 103 to the processor of the medical imaging apparatus takes place. A transfer as used herein may be a download of the examination protocol, but may also be a mere display or representation on an output interface of the medical examination apparatus 101, so that the examination parameters are then transferred manually to the medical examination apparatus 101.

In step 208, an optional step, an assessment is made of the transferred selected examination protocol.

In step 209, also an optional step, the at least one examination protocol is displayed in accordance with the assessment of the transferred selected examination protocol. An assessment is to be understood here as being an evaluation of the executed examination protocol, i.e. of whether the expectations for the examination protocol were fulfilled. This evaluation can be effected by a traffic-light representation (green, amber, red), by a numerical-grade representation (from 1 to 6) or by a different representation with a different scale. The assessment here also includes a transfer of the assessment to the server 103. If this assessment is transferred back to the server 103, it can function as an additional criterion for selecting an examination protocol. The assessment consequently allows a user to obtain information about the underlying method and thus helps the user to contribute to the user's decision. A number of assessments of a number of examination protocols are averaged in order to smooth out outliers and to offer a better cross-section of user experience.

A last step 210 designates the end of the method for optimizing an examination implemented by a medical imaging apparatus 101.

FIG. 3 is a flowchart of the method according to the invention for optimizing an examination implemented by a test apparatus. The method includes the steps 301 to 308, parts of the description including the corresponding reference characters introduced in connection with FIG. 1 also being used in the description of the steps 301 to 308.

A first step 301 designates the start of the method for optimizing an examination implemented by a test apparatus 102 of a medical imaging apparatus 101. Here, a test apparatus 102 is to be understood as a medical imaging apparatus 101 by which an examination protocol is tested and subsequently made available.

With the use of this method, those examination protocols which can be selected by means of the method for optimizing an examination by a medical imaging apparatus 101 are thus generated. In other words, with the use of this method, a database is generated.

First an examination protocol that includes at least one examination parameter is created. Creating means specifying the necessary examination parameters.

In step 302, an examination protocol, that includes at least one examination parameter, is created. Creating means specifying the necessary examination parameters.

Step 303 designates the creation of an information protocol forming part of the examination protocol, the information protocol including at least one information parameter.

An information parameter may, for example but not exclusively, be:
a type of institution, such as e.g. a university clinic, a hospital or an imaging center,
a number of rooms and/or beds,
a hardware version of a medical imaging device used,
a software version of a medical imaging device used,
qualitative examination targets, such as e.g. an examination time, a noise level or an image resolution,
patient data, such as e.g. age, height, physique or breath-holding capabilities,
types of examination protocols, such as e.g. body region, contrast agent, relaxation times or a number of dimensions.

In step 304, at least one information parameter of the information protocol is selected automatically. This is possible because the processor of the test apparatus 102 should “know” hardware and software versions of the test apparatus 102, for example. As a result, such variables can be read in automatically, which reduces the error susceptibility and the time required.

In step 305, the examination protocol and the information protocol are transferred to a server 103.

Step 306, an optional step, designates an assessment of the transferred examination protocol. An assessment means an evaluation of the executed examination protocol, i.e. of whether the expectations for the examination protocol were fulfilled. This evaluation can be effected by a traffic-light representation (green, amber, red), by a numerical-grade representation (from 1 to 6) or by a different representation with a different scale. The assessment here also includes a transfer of the assessment to the server 103. The assessment allows a user to obtain information about the underlying method and thus helps the user to contribute to the user's decision.

Step 307 is also an optional step, and designates the storage of the assessment as an information parameter. A user can consequently also search selectively for defined assessments and for example specify a threshold for an assessment value and thereby ensure that only protocols that lie e.g. above this threshold value are obtained.

Step 308 designates the end of the method for optimizing an examination by a test apparatus 102 of a medical imaging apparatus 101.

In summary, the invention concerns a method for optimizing an examination implemented by a medical imaging apparatus, wherein at least one information protocol is selected that includes at least one information parameter, at least one examination protocol is displayed that includes at least one examination parameter from an examination protocol catalog of a server in accordance with the selected information protocol, an examination protocol is then selected, and the selected examination protocol is transferred from the server to the processor of the medical imaging apparatus.

In a preferred embodiment, the method includes an assessment of the transferred selected examination protocol, at least one information parameter of the information protocol is selected automatically, and the selected examination protocol includes at least one guideline variable.

Although modifications and changes may be suggested by those skilled in the art, it is the intention of the inventor to embody within the patent warranted hereon all changes and modifications as reasonably and properly come within the scope of her contribution to the art.

I claim as my invention:

1. A method for optimizing an examination implemented by a medical imaging apparatus, comprising:
selecting at least one information protocol, comprising at least one information parameter;
displaying at least one examination protocol, comprising at least one examination parameter from an examination protocol catalog of a server in accordance with the selected information protocol;
selecting of an examination protocol from said catalog that is displayed; and
transferring the selected examination protocol from the server to a processor that operates the medical imaging apparatus.

2. The method as claimed in claim 1, further comprising an automatically assessing of the transferred selected examination protocol in said processor.

3. The method as claimed in claim 2, comprising displaying at least one examination protocol dependent on the assessment of the transferred selected examination protocol.

4. The method as claimed in claim 1, comprising selecting said at least one information parameter of the information protocol automatically.

5. The method as claimed in claim 1, wherein the selected examination protocol comprises at least one guideline variable.

6. A method for optimizing an examination implemented by a test apparatus of a medical imaging apparatus, comprising:
creating an examination protocol, comprising at least one examination parameter;
creating an information protocol forming part of the examination protocol, said information protocol comprising at least one information parameter; and
transferring the examination protocol and of the information protocol to a server.

7. The method as claimed in claim 6, further comprising automatically assessing the transferred examination protocol.

8. The method as claimed in claim 7, comprising storing a result of the assessment as an information parameter.

9. The method as claimed in claim 6, comprising automatically selecting said at least one information parameter of the information protocol.

10. A method for optimizing an examination implemented by a server that categorizes examination protocols, said examination protocols respectively comprising at least one examination parameter, and information protocols forming part of the examination protocols, said information protocols respectively comprising at least one information parameter, which are transferred to the server, in accordance with information from the examination protocols and/or information protocols.

11. A medical imaging apparatus comprising:
a medical imaging scanner;
a user interface in communication with said medical image scanner, said user interface being configured to allow a user to select at least one information protocol, comprising at least one information parameter;
a server in communication with said user interface;
said user interface comprising a display monitor at which said user interface is configured to display at least one examination protocol, comprising at least one examination parameter from an examination protocol catalog provided by said server in accordance with the selected information protocol;
said user interface being configured to allow a user to select an examination protocol from said catalog that is displayed; and
said user interface being configured to transfer the selected examination protocol from the server to a control computer that operates the medical imaging scanner.

12. A test apparatus for optimizing a medical imaging examination, said test apparatus comprising:
a medical imaging test device;
a processor configured to create an examination protocol, comprising at least one examination parameter;
said processor being configured to create an information protocol forming part of the examination protocol, said information protocol comprising at least one information parameter; and
said processor being configured to transfer the examination protocol and of the information protocol to a server.

13. A server that participates in optimizing an examination implemented by a medical imaging apparatus, said server being configured to categorize examination protocols, said examination protocols respectively comprising at least one examination parameter, and information protocols forming part of the examination protocols, said information protocols respectively comprising at least one information parameter, which are transferred to the server, in accordance with information from the examination protocols and/or information protocols.

14. A non-transitory, computer-readable storage medium encoded with programming instructions, said storage medium being loaded into a distributed computer system of a medical imaging apparatus, said distributed computer system comprising a control computer and a server and said programming instructions causing said distributed computer system to:
receive a selection of at least one information protocol, comprising at least one information parameter;
display at least one examination protocol, comprising at least one examination parameter from an examination protocol catalog of said server in accordance with the selected information protocol;
receive a selection of an examination protocol from the catalog that is displayed; and
transfer the selected examination protocol from the server to the control computer to operate the medical imaging apparatus. therewith.

15. A non-transitory, computer-readable data storage medium encoded with programming instructions, said storage medium being loaded into a control computer of a test apparatus of a medical imaging apparatus, and said programming instructions causing said control computer to:
create an examination protocol, comprising at least one examination parameter;
create an information protocol forming part of the examination protocol, said information protocol comprising at least one information parameter; and
transfer the examination protocol and of the information protocol to a server.
